(19) United States
(12) Patent Application Publication
(10) Pub. No.: US 2025/0276926 A1
(43) Pub. Date: Sep. 4, 2025

(54) MBR SYSTEM

(71) Applicant: AMOGREENTECH CO., LTD., Gimpo-si (KR)

(72) Inventor: Jin LEE, Gimpo-si (KR)

(73) Assignee: AMOGREENTECH CO., LTD., Gimpo-si (KR)

(21) Appl. No.: 19/213,074

(22) Filed: May 20, 2025

Related U.S. Application Data
(63) Continuation of application No. 17/621,839, filed on Dec. 22, 2021.

(30) Foreign Application Priority Data
Sep. 11, 2020 (KR) 10-2020-0117166

(51) Int. Cl. C02F 3/12; B01D 63/08

(52) U.S. Cl. CPC C02F 3/1273; B01D 63/0822; B01D 2239/0618; B01D 2239/1291; C02F 2209/03; C02F 2209/40; C02F 2301/066; C02F 2303/06

(57) ABSTRACT

Disclosed is a membrane bioreactor (MBR) system. The MBR system according to one embodiment of the present invention includes a membrane filtration tub, a filtration portion including a filter member and installed in the membrane filtration tub, a filtered water storage tank, an air tank configured to store air to be supplied to the filtration portion, a flow channel portion including a first flow channel configured to connect the filtration portion to the filtered water storage tank and a second flow channel configured to connect the filtration portion to the air tank, a valve portion including a first valve located on the first flow channel and configured to open or close the first flow channel and a second valve located on the second flow channel and configured to open or close the second flow channel, and a decompression portion.

### CROSS-REFERENCE TO RELATED APPLICATIONS

This application is a continuation application of U.S. application Ser. No. 17/621,839, filed Dec. 22, 2021, which is a 35 U.S.C. 371 National Phase Entry Application from PCT/KR2021/012288 filed Sep. 9, 2021, which designates the United States and claims the benefit of Korean Patent Application No. 10-2020-0117166 filed on Sep. 11, 2020, the disclosures of which are incorporated herein by reference in their entireties.

### TECHNICAL FIELD

The present invention relates to a membrane bioreactor (MBR) system, and more particularly, to an MBR system using a plate-and-frame-type filter device.

### BACKGROUND

Due to rapid industrial development, the cityward tendency of population, and the like, an amount of wastewater discharged from living spaces and industrial facilities has increased. Accordingly, a variety of wastewater treatment facilities for economically and efficiently treating wastewater have been developed.

Generally, in a wastewater treatment facility, a plurality of filters including a filter member configured to filter wastewater are installed. Contaminants filtered out from the wastewater remain on a surface of the filter member which has filtered the wastewater.

However, when the filter member contaminated with contaminants is continuously operated, a differential pressure of a membrane notably increases such that filtration efficiency is significantly degraded and it becomes impossible to perform water treatment operation itself in a serious case.

To this end, hitherto, air has been jetted toward a surface of a membrane so as to remove contaminants on the surface of the membrane in order to remove contaminants present on the surface of the filter member, or a washing process has been periodically performed on the filter member using a chemical washing method of removing contaminants in a filtration tub in which the filter member is included using a washing material such as citric acid and the like. However, in the case of washing a membrane using air, even when an air jet pressure is high, it is difficult to remove contaminants present inside the membrane not on a surface of the membrane and a physical damage of the surface of the membrane is even caused.

Also, in the case of washing using chemicals, there are problems such as an increase in cost, contamination of water, and the like which are caused by using chemicals and there is a risk that a membrane is chemically damaged by chemicals.

In order to remedy such problems, there is provided a washing method of removing contaminants outward not only on a surface of the membrane but also in the membrane by allowing uncontaminated water to pass in a direction opposite a filtration direction in which raw water passes through a membrane. A washing method using water has an advantage in which a membrane is not chemically damaged and there is no contamination of water in washing. However, in the washing using water, since filtered water is used generally as wash water and is allowed to pass, at a pressure higher than a filtrated flow rate by 1.5 to 3 times, in a direction opposite a filtration direction, a large amount of filtered water is used as wash water and thus an output of the filtered water is decreased. Particularly, when a washing cycle is set to be short to maintain membrane performance for a long time, a decrease in the output of filtered water may be a critical problem in securing a flow rate.

In addition, in the case of a conventional flat sheet membrane, a multiple structure in which several filter members are stacked is applied. Here, when water at a pressure higher than a filtration flow rate passes in a direction opposite a filtration direction, a high pressure may be applied to a contaminated flat sheet membrane. Accordingly, there is a risk that delamination may occur in the membrane having the multiple structure and thus the flat sheet membrane may lose a filtration function thereof.

Accordingly, it is urgent to develop a membrane bioreactor (MBR) system capable of performing a long-term water treatment operation while minimizing degradation of the flat sheet membrane when raw water such as sewage, wastewater, and the like is treated using a filter module using a flat sheet membrane and capable of minimizing or preventing a loss of filtered water produced while the flat sheet membrane is washed.

### SUMMARY OF THE INVENTION

The present invention is directed to providing a membrane bioreactor (MBR) system capable of minimizing degradation of a filter member and performing a long-term water treatment operation while raw water is treated using the filter member and capable of preventing or minimizing usage of filtered water produced in washing the filter member so as to increase efficiency in producing the filtered water.

One aspect of the present invention provides a membrane bioreactor (MBR) system including a membrane filtration tub configured to contain raw water including activated sludge at a concentration of 3,000 to 15,000 mg/l, a filtration portion including a filter member and installed in the membrane filtration tub to filter the raw water, a filtered water storage tank disposed outside the membrane filtration tub and configured to store the filtered water produced from the filtration portion, an air tank configured to store air to be supplied to the filtration portion to remove contaminants on a surface of a filter member, a flow channel portion including a first flow channel configured to connect the filtration portion to the filtered water storage tank and a second flow channel configured to connect the filtration portion to the air tank, a valve portion including a first valve located on the first flow channel and configured to open or close the first flow channel and a second valve located on the second flow channel and configured to open or close the second flow channel, and a decompression portion located on the first flow channel between the filtered water storage tank and the first valve. Here, the MBR system repetitively performs one cycle including a first operation in which filtered water is produced by allowing raw water to pass through from an outside to an inside of the filter member using a pressure difference between the outside and inside of the filter member which is formed by driving the decompression portion and transferring the produced filtered water to the filtered water storage tank through the first flow channel while the first valve is opened and the second valve is closed and a second operation in which the air stored in the air tank is transferred to the filter member through the second flow channel by closing the first valve and opening the second valve and contaminants on the filter member contaminated due to the first operation are removed by allowing the transferred air to pass through from the inside to the outside of the filter member.

The valve portion may further include a third valve connected to outside air on the first flow channel between the first valve and the filtration portion. Here, the cycle may further include a third operation of ventilating the filtration portion, in which the air remains due to the second operation, with outside air by closing the second valve and opening the third valve after the second operation is finished.

The first operation may be performed so that a membrane filtration flow velocity is to be 10 to 40 LMH.

In the second operation, a pressure of the air may exceed 100 kPa.

A side of the second flow channel, which is opposite a side connected to the air tank, may communicate with a certain point on the first flow channel between the first valve and the filtration portion and may be connected to the filtration portion via the first flow channel. Here, in the second operation, filtered water remaining in the first flow channel between the first valve and the filtration portion and the second flow channel between the second valve and the filtration portion may pass, with the air, through from the inside to the outside of the filter member so as to remove the contaminants on the filter member. Here, a pressure of the air may be 10 to 100 kPa. An average opening diameter of a surface of the filter member which faces raw water may be 0.5 μm or less.

The first operation may be performed at a membrane filtration flow velocity of 10 to 40 LMH for 5 to 15 minutes. Here, the second operation may be performed using air at a pressure of 10 to 100 kPa for 10 to 60 seconds. Also, the third operation may be performed for 10 to 120 seconds.

When the first operation is performed at a membrane filtration flow velocity of 20 LMH, a differential pressure of the filtration portion after 100 days may vary to be 10 kPa or less in comparison to an initial differential pressure.

The filtration portion may be a plate-and-frame-type filter device including a filter assembly in which a plurality of filter units which are flat sheet membranes are integrated using a fastening bar as a medium and at least one common collecting member configured to collect filtered water discharged from the plurality of filter units. Here, the filter unit may include a filter member which is a flat sheet membrane having a filtration flow from an outside, which includes both surfaces, to an inside, and a support frame coupled to an edge side of the filter member to support the filter member and in which a flow channel through which the filtered water produced using the filter member flows in and moves and a receiving hole configured to discharge the filtered water are formed. The common collecting member may be connected to be matched one to one with the receiving hole, which is provided in each of the plurality of filter units.

The filter member may include a plate-shaped first support body and fiber webs formed of nanofibers and disposed on both sides of the first support body.

The fiber webs may be attached to surfaces of the first support body using second support bodies having a thickness smaller than the first support body as media through thermal fusion.

The first support body and the second support bodies may be sheath-core composite fibers including a core portion formed of polypropylene and a sheath portion formed of polyethylene having a melting point at a temperature of 60 to 180° C.

According to the present invention, when raw water is treated, a long-term water treatment operation may be performed while minimizing performance degradation such as an increase in differential pressure and the like caused by an increase in contamination of a filter member and a loss of produced filtered water which occurs due to washing of the filter member in washing using the filtered water may be minimized or prevented so as to increase efficiency of producing filtered water.

### BRIEF DESCRIPTION OF THE DRAWINGS

FIG. 1 is a schematic diagram of a sewage treatment system according to one embodiment of the present invention;

FIG. 2 is a schematic diagram illustrating a plate-and-frame-type filter device according to one embodiment of the present invention which is used in the sewage treatment system of FIG. 1, and the diagram illustrates a state in which any one of a plurality of filter modules is separated from a main frame;

FIG. 3 is a view illustrating the filter module according to one embodiment of the present invention;

FIG. 4 is an enlarged view illustrating a coupling relationship between an interval adjusting member and a fastening bar in FIG. 3;

FIG. 5 is a view illustrating another form of a reception hole in the filter module according to one embodiment of the present invention;

FIG. 6 is a view illustrating a filter unit according to one embodiment of the present invention;

FIG. 7 is a cross-sectional view illustrating a frame applied to FIG. 6;

FIG. 8 is a view illustrating a movement path on which filtered water flows from the filter unit toward the reception hole according to one embodiment of the present invention; and

FIGS. 9A to 13 are graphs illustrating results of sewage treatment performed using sewage treatment systems according to a variety of embodiments of the present invention and sewage systems according to a variety of comparative examples.

### DETAILED DESCRIPTION

Hereinafter, embodiments of the present invention will be described in detail to be implemented by one of ordinary skill in the art with reference to the drawings. The present invention may be implemented in a variety of shapes and will not be limited to the embodiments described herein. To clearly describe the present invention, a description of an irrelevant part will be omitted from the drawings. Throughout the specification, like or similar components will be referred to as like reference numerals.

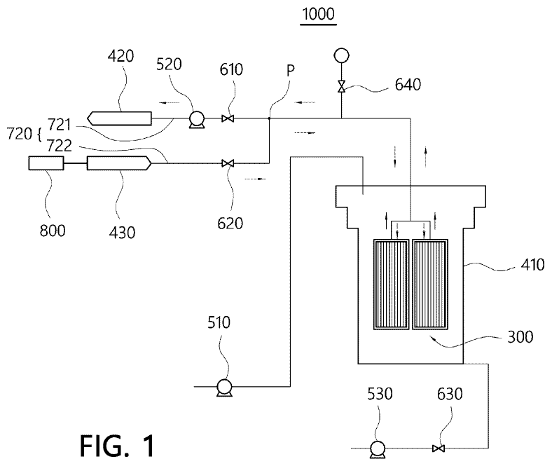

Referring to FIG. 1, a membrane bioreactor (MBR) system 1000 according to one embodiment of the present invention includes a membrane filtration tub 410 containing raw water, a filtration portion 300 installed in the membrane filtration tub to filter the raw water, a filtered water storage tank 420 disposed outside the membrane filtration tub 410 and configured to store the filtered water produced from the filtration portion 300, an air tank 430 which stores air supplied to the filtration portion 300 to remove contaminants on a surface of a filter member in the filtration portion 300, a flow channel portion 720 including a first flow channel 721 configured to connect the filtration portion 300 to the filtered water storage tank 420 and a second flow channel 722 configured to connect the filtration portion 300 to the air tank 430, a valve portion including a first valve 610 located on the first flow channel 721 and configured to open or close the first flow channel 721 and a second valve 620 located on the second flow channel 722 and configured to open or close the second flow channel 722, and a decompression portion 520 located on the first flow channel 721 between the filtered water storage tank 420 and the first valve 610. Also, a raw water supply flow channel and a raw water supply pump 510 which are configured to suction raw water into the membrane filtration tub 410 may be further included. Also, a filtrate discharge flow channel configured to transfer foreign matter remaining after filtering raw water using the filtration portion 300 to the outside of the membrane filtration tub 410 and a filtrate discharge pump 530 may be further included. Here, a discharge adjusting valve 630 configured to open the filtrate discharge flow channel only when a filtrate is discharged may be further provided on the filtrate discharge flow channel.

The MBR system 1000 according to one embodiment of the present invention may be operated by repetitively performing a cycle including a first operation in which filtered water is produced by allowing raw water to pass through from the outside to the inside of the filter member using a pressure difference between the outside and inside of the filter member which is formed by driving the decompression portion 520 and transferring the produced filtered water to the filtered water storage tank 420 through the first flow channel 721 while the first valve 610 is opened and the second valve 620 is closed and the cycle including a second operation in which the air stored in the air tank 430 is transferred to the filter member through the second flow channel by closing the first valve 610 and opening the second valve 620 and contaminants on the filter member contaminated due to the first operation are removed by allowing the transferred air to pass through from the inside to the outside of the filter member.

First, the raw water that is a target to be treated is sewage in which the concentration of activated sludge is 3,000 to 15,000 mg/l and may be, for example, sewage which flows into a general sewage treatment plant and is pretreated using an aeration tank or the like employing a diffuser before flowing into the membrane filtration tub 410. Also, the sewage may be rainwater, foul water, effluent, or a mixture of two or more thereof. The raw water may be, for example, supplied to the membrane filtration tub 410 through the raw water supply pump 510.

Also, the membrane filtration tub 410 may have an internal space capable of accommodating suctioned raw water and may be installed in a general wastewater treatment plant.

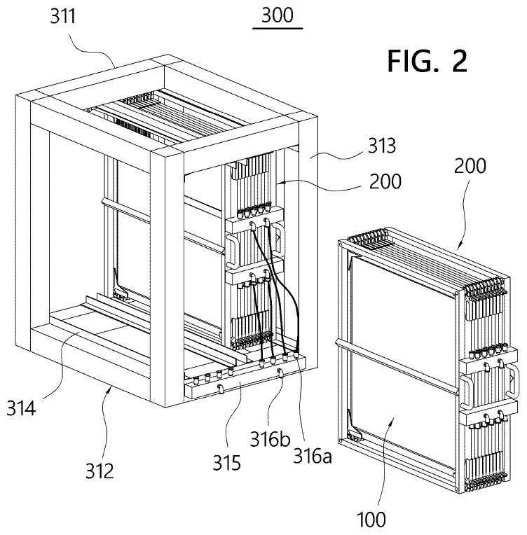

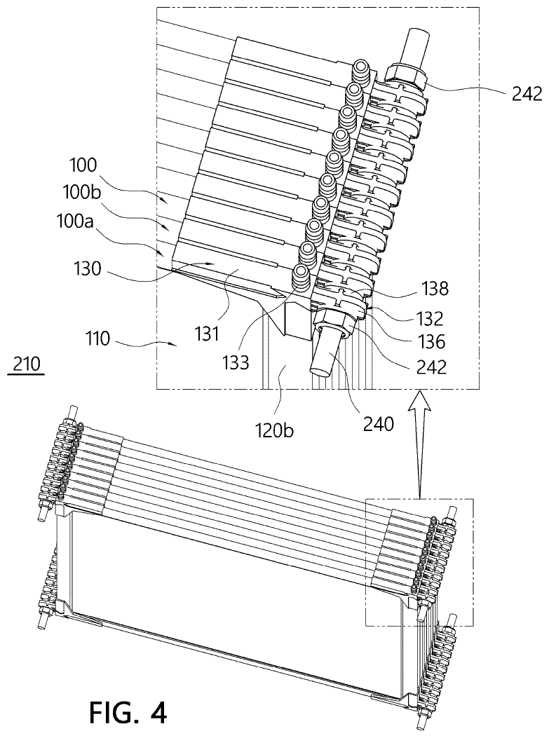

Also, the filtration portion 300 configured to filter the suctioned raw water is disposed in the internal space of the membrane filtration tub 410. The filtration portion 300 may be any well-known filter devices used in an MBR system and may be, for example, a plate-and-frame-type filter device employing the filter member shown in FIGS. 2 to 8 which is a flat sheet membrane.

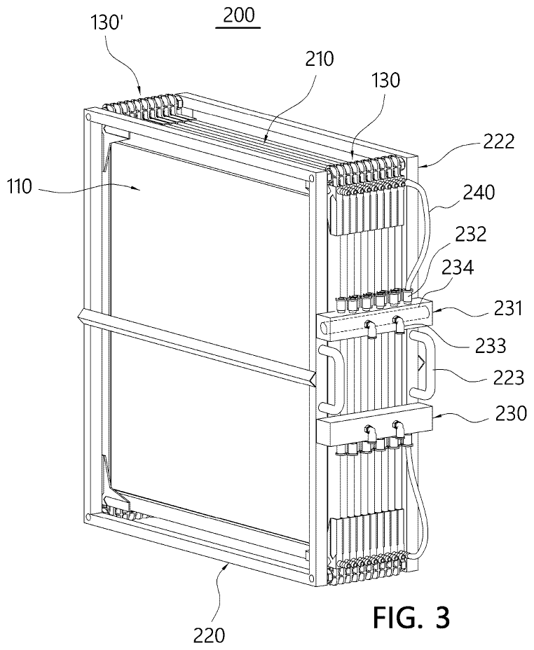

As an example, the filtration portion 300 which is a plate-and-frame-type filter device may include, as shown in FIG. 2, at least one filter module 200. The filter module 200 may include, as shown in FIGS. 3 to 5, a filter assembly 210 including a plurality of filter units 100 integrated using a fastening bar as a medium, at least one common collecting member 230 configured to collect filtered water discharged from the plurality of filter units 100, and a fixing frame 220.

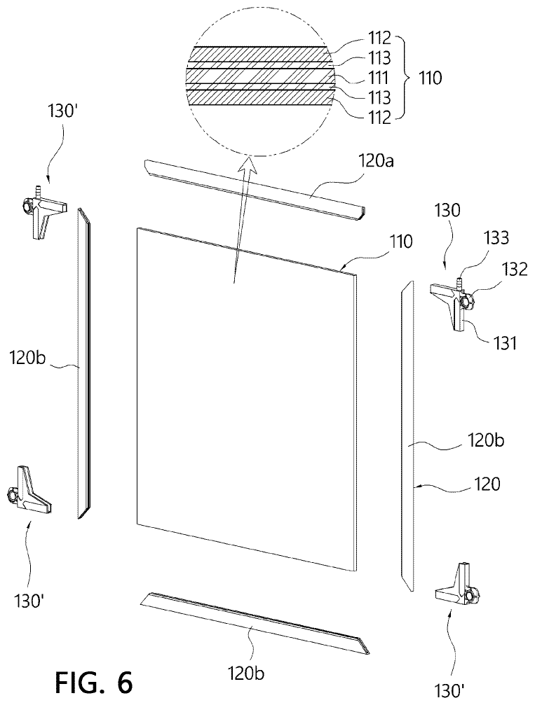

Referring to FIGS. 6 to 8, the filter unit 100 may include a filter member 110 and a support frame 120 coupled to an edge of the filter member 110 and may further include interval adjusting members 130 and 130′.

The filter member 110 is a member configured to filter out foreign matter included in sewage, and a well-known filter member may be used. However, the filter member 110 may be designed to have a filtration flow from an outside, which includes both surfaces, to an inside which is an inner part of the filter member 110. As an example of being designed to have the filtration flow, the filter member 110 may have a plate shape in which fiber webs 112 formed of nanofiber are disposed on both sides of a first support body 111.

Here, the fiber web 112 is configured to filter out foreign matter included in raw water while the raw water passes through the filter member 110 due to decompression portion 520, and the first support body 111 may support the fiber web 112 and perform a function of a movement path in which filtered water produced by the fiber web 112 moves.

Here, the filter member 110 may have a triple structure in which the fiber webs 112 are directly attached to both sides of the first support body 111 or may have a quintuple structure in which the fiber webs 112 are attached to both sides of the first support body 111 with second support bodies 113 as media therebetween.

Here, a thickness of the first support body 111 may be thicker than a thickness of each of the second support body 113 and the fiber web 112. As an example, the thickness of the first support body 111 may occupy 90% or more of an overall thickness of the triple structure or quintuple structure filter member 110. Accordingly, even when a high pressure is applied to the filter member 110 during the first operation which is a filtration process or the second operation which is a washing process which will be described below, a supporting force capable of preventing the filter member 110 from being damaged or deformed may be easily applied.

Meanwhile, in the triple structure, the first support body 111 and the fiber webs 112 may be attached to each other through thermal fusion. Here, when the first support body 111 occupies most of the overall thickness of the filter member 110, in order to melt a part of a surface of the first support body 111, it is necessary to apply high-temperature heat for a long time to exceed thermal capacity of the first support body 111 while the fiber webs 112 are disposed on both sides of the first support body 111. Accordingly, there is a risk that unintended deformation or damage may occur to the fiber webs 112. However, in the case of the quintuple structure, the first support body 111 and the fiber webs 112 are attached to each other with the second support bodies 113 having a thickness much thinner than that of the first support body 111 so as to prevent the fiber webs 112 from being melted or deformed.

As an example, the fiber webs 112 may be attached to the first support body 111 with the second support bodies 113 as media through thermal fusion, ultrasonic fusion, high-frequency fusion, or the like. Here, the second support bodies 113 may be formed of composite fibers including a core portion which is support fiber and a sheath portion having a lower melting point than the support fiber and covering an outer surface of the support fiber. A part or an entirety of the sheath portion may be melted so as to be easily coupled to the first support body 111 and the fiber webs 112 with higher bonding strength. As an example, the composite fibers may be sheath-core composite fibers including a core portion which is polypropylene and a sheath portion which is polyethylene having a melting point of 60 to 180° C. Accordingly, there is an advantage of minimizing delamination or damage of the filter member 110 despite pressure variations in the first operation which are applied through the decompression portion 520 and high-pressure air applied in the second operation. Particularly, in the case of low melting point composite fibers in which different materials, for example, polyester components having different melting points, are disposed in a sheath portion and a core portion, even when bonding is possible at similar temperature conditions, bonding is not easy or bonding may be easily broken due to brittleness of materials. Also, there is a risk that delamination is accelerated by pressures applied in the first operation and the second operation.

Also, like the second support bodies 113, the first support body 111 may also be a member formed of sheath-core composite fibers including a core portion which is polypropylene and a sheath portion which is polyethylene having a melting point of 60 to 180° C. Accordingly, high bonding strength may be provided due to an increase in compatibility between the first support body 111 and the second support bodies 113 so that delamination may be further minimized in the first operation and the second operation.

The first support body 111 and the second support bodies 113 may be porous materials so as to perform a function of a movement path in which filtered water produced by the fiber webs 112 moves. As an example, the first support body 111 and/or the second support bodies 113 may be any one of a well-known fabric, knitted fabric, and non-woven fabric which are generally used and may be, for example, a non-woven fabric.

Also, a thickness of the first support body 111 may be, for example, 2 to 8 mm, particularly, 2 to 5 mm, and more particularly, 3 to 5 mm. When the thickness is less than 2 mm, adequate mechanical strength capable of enduring frequent washing may not be provided. Also, in the case of the thickness exceeding 8 mm, when the filter member is implemented as a filter unit and then assembled in a limited space to be implemented as a module, a degree of integration of the filter member per unit volume of the module may be reduced.

Preferably, the first support body 111 may satisfy the above-described thickness conditions and may have an average basis weight of 250 to 800 g/m², and more particularly, 350 to 600 g/m². When the average basis weight is less than 250 g/m², it is difficult to provide adequate mechanical strength and bonding force with the second support bodies is reduced. When the average basis weight exceeds 800 g/m², an adequate flow channel is not formed such that a flow rate may be reduced and a differential pressure increases such that it is difficult to easily perform washing.

Also, the second support bodies 113 may be, for example, non-woven fabrics. Here, fibers forming the second support bodies 113 may have an average diameter of 5 to 30 μm. Also, a thickness of the second support body 113 may be, for example, 100 to 400 μm, particularly, 150 to 400 μm, and more particularly, 150 to 250 μm, and may be, for example 200 μm.

Also, the second support bodies 113 may have an average diameter of 20 to 100 μm and have a porosity of 50 to 90%. However, the present invention is not limited thereto.

Also, an average basis weight of the second support body 113 may be, for example, 10 to 200 g/m², particularly, 35 to 200 g/m², and more particularly, 35 to 80 g/m², and may be, for example 40 g/m². When the average basis weight is less than 10 g/m², an amount of fiber forming the second support body which are distributed on an interface between the fiber web and the second support body may be small. Accordingly, an effective adhesive area of the second support body in contact with the fiber web may be reduced such that it is impossible to provide a desired level of coupling force. Also, adequate mechanical strength for supporting the fiber web may not be provided and there may be a problem that a bonding force with the first support body is reduced. Also, when the average basis weight exceeds 200 g/m², it is difficult to secure a targeted level of flow rate and there may be a problem that a differential pressure increases and thus it is difficult to easily perform backwashing.

The fiber web 112 is configured to filter out foreign matter included in the raw water and may be formed using nanofibers. As an example, the nanofibers may include a fiber forming component including polyacrylonitrile (PAN) and polyvinylidene fluoride (PVDF) and an emulsionizing agent configured to improve miscibility of the fiber forming component. Here, the fiber forming component may include polyacrylonitrile having high hydrophilicity (hereinafter, referred to as PAN) and polyvinylidene fluoride having high hydrophobicity (hereinafter, referred to as PVDF). Mechanical strength and chemical resistance of nanofibers may be achieved using PVDF. Using PAN, nanofibers may be prevented from being hydrophobic due to PVDF and the hydrophilicity of nanofibers may be improved so as to implement improved water permeability when nanofibers are attached to the filter member.

Also, the nanofibers may have an average diameter of 0.05 to 1 μm and an aspect ratio of 1,000 to 100,000 but are not limited thereto. As an example, the nanofibers included in the fiber web 112 may include a first nanofiber group having a diameter of 0.1 to 0.2 μm, a second nanofiber group having a diameter of 0.2 to 0.3 μm, and a third nanofiber group having a diameter of 0.3 to 0.4 μm, which are 35% by weight, 53% by weight, and 12% by weight of an entire weight of the fiber web 112, respectively.

Also, the fiber web 112 may have a thickness of 0.5 to 200 μm, and for example, 20 μm. The fiber web 112 may have a porosity of 40 to 90%, and more particularly, 60 to 90%. Also, an average opening diameter may be 0.1 to 5 μm, and more particularly, 0.1 to 3 μm, and for example, 0.25 μm. Also, the fiber web 112 may have an average basis weight of 0.05 to 20 g/m², and for example, 10 g/m² but is not limited thereto and may be adequately changed in consideration of desired water permeability and filtration efficiency.

Also, the fiber web 112 may include a single layer or a multilayer.

Meanwhile, the support frame 120 is disposed on an edge side of the filter member 110 and supports the edge side of the filter member 110 so as to allow the filter member 110 to maintain a plate shape.

The support frame 120 may include a single member to support an entirety or a part of the edge side of the filter member 110 or may include a plurality of frames 120a and 120b being coupled to the edge side of the filter member 110.

As an example, the plurality of frames 120a and 120b may be disposed on the edge side of the filter member 110 so that one end may come into contact with another end. Ends of the two neighboring frames 120a and 120b may be connected to each other using the interval adjusting members 130 and 130′ which are disposed on corner sides of the filter member 110.

However, a shape of the support frame is not limited thereto and may be a variety of shapes including a circular shape, an arc shape, a polygonal shape, and a combination thereof according to a shape of the filter member 110. Also, it should be noted that the shape of the support frame may be any shape that surrounds the edge of the filter member overall.

Here, the support frame 120 may perform a function of supporting the filter member 110 and perform a function of a flow channel through which filtered water produced by the filter member 110 is moved to a receiving hole 133 using a suctioning force provided by the decompression portion 520.

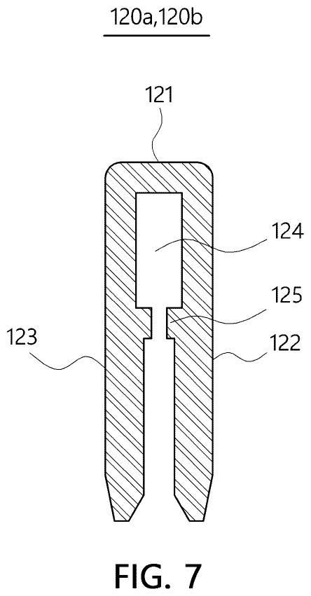

To this end, each of the frames 120a and 120b included in the support frame 120 may have an approximate staple shape with one open side and may include a flow channel 124 therein through which filtered water suctioned from the filter member 110 flows (refer to FIG. 7).

In detail, the plurality of frames 120a and 120b may include a first plate 121 having a plate shape and a pair of second plates 122 and 123 vertically extending from both ends of the first plate 121. Accordingly, the edge side of the filter member 110 is inserted into a space formed between the pair of second plates 122 and 123 so that the filter member 110 may be supported by the pair of second plates 122 and 123. Here, the edge side of the filter member 110 may be inserted into the space between the pair of second plates 122 and 123 to be spaced at a certain distance apart from the first plate 121.

That is, restriction members 125 configured to restrict an insertion depth of the filter member 110 may be provided on facing surfaces of the pair of the second plates 122 and 123 which face each other. Accordingly, since the insertion depth of the filter member 110 is restricted by the restriction members 125 while the edge side of the filter member 110 is fastened to the frames 120a and 120b, a certain space may be formed between the first plate 121 and an end of the edge side of the filter member 110.

Accordingly, since the edge of the filter member 110 always maintain a state of being spaced apart from the first plate 121 when the filter member 110 and the frames 120a and 120b are coupled, the flow channel 124 through which filtered water produced through the first operation or air applied in the second operation is movable may be formed.

In the present invention, the restriction members 125 may be formed on the facing surfaces of the pair of second plates 122 and 123 or may be formed on only one of inner surfaces of the pair of second plates 122 and 123. In addition, the restriction member 125 may be overall or partially provided along a longitudinal direction of each of the frames. Also, when the restriction members 125 are formed respectively on the facing surfaces of the pair of second plates 122 and 123 which face each other, the respective restriction members 125 may be disposed to be spaced at a certain interval apart so as to allow filtered water to be movable toward the flow channel 124 through the interval.

The interval adjusting members 130 and 130′ are configured to be coupled to the corner sides of the support frame 120 and to fasten the two neighboring frames 120a and 120b and, simultaneously, to adjust an interval between the neighboring filter members 110.

A plurality of such interval adjusting members 130 and 130′ may be provided and coupled to the corner sides of the support frame 120 so as to fix the ends of the two neighboring frames 120a and 120b.

To this end, the interval adjusting members 130 and 130′ may include bodies 131 having one open side to allow the ends of the neighboring frames 120a and 120b to be insertable therein.

Accordingly, among the plurality of frames 120a and 120b included in the support frame 120, two neighboring frames 120a and 120b may be fixed to the body 131 by inserting the ends thereof into the body 131.

As an example, the end of any one frame 120a of the two neighboring frames 120a and 120b may be inserted in a first direction of the body 131 and the end of the other frame 120b may be inserted in a second direction of the body 131 so as to come into contact with the end of the frame 120a inserted in the first direction.

Here, the flow channel 124 formed in the frame 120a inserted in the first direction and the flow channel 124 formed in the frame 120b inserted in the second direction are disposed to communicate with each other so as to allow all of the flow channels formed in the plurality of frames 120a and 120b to communicate with each other.

Here, the first direction and the second direction may be directions intersecting with each other in the same plane or may be directions tilted to have a certain angle with respect to one straight line in the same plane.

Meanwhile, a plurality of such filter units 100 may be arranged to be parallel to one another. Here, an interval adjusting hole 132 may be provided to allow the respective filter members 110 to be spaced at an interval apart from each other.

The interval adjusting hole 132 may be provided in at least one of the plurality of frames 120a and 120b included in the support frame 120 or may be provided in at least one of the interval adjusting members 130 and 130′.

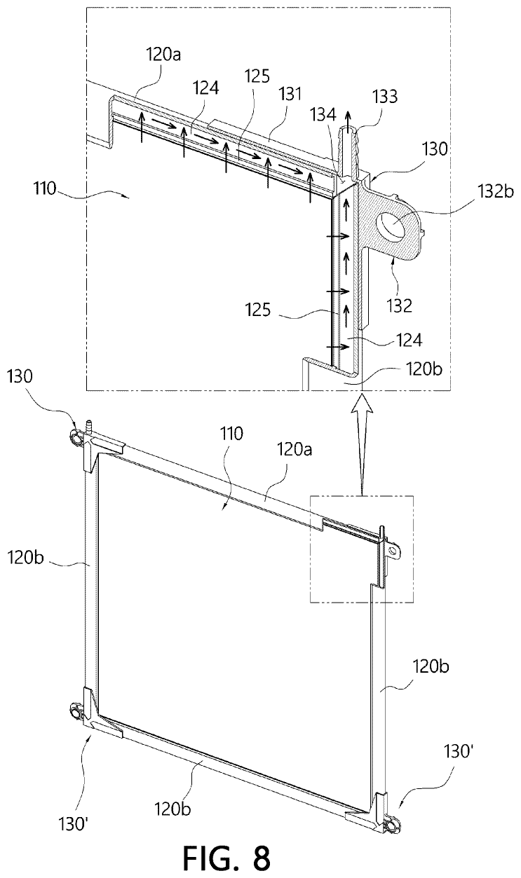

As an example, the interval adjusting hole 132 may include an extension plate in which a fastening hole 132b is formed and a spacing member and may be formed in one sides of the interval adjusting members 130 and 130′ (refer to FIG. 8).

In detail, the extension plate may extend outward from the body 131 of the interval adjusting member 130 or 130′ and may include the fastening hole 132b through which a fastening bar 240 passes. Here, the fastening hole 132b is illustrated as circularly passing through the extension plate in the drawing but is not limited thereto and may have a shape corresponding to a cross-sectional shape of the fastening bar 240. As an example, the fastening hole 132b may be formed to have a circular shape, an arc shape, a polygonal cross section, or a combination thereof.

Here, the spacing member may protrude to a certain height from one surface of the extension plate to have a certain thickness. The spacing member may be provided to entirely or partially surround an edge of the fastening hole 132b.

Here, the spacing member may be formed on each of both sides of the extension plate 132a or may be formed on only one surface of the extension plate 132a or may be formed to have a multistage structure having different heights from one surface of the extension plate 132a.

Here, the interval between the plurality of filter members 110 arranged to be parallel to each other may be 3 mm or more but is not limited thereto and a variety of intervals may be provided by adequately changing a height or thickness of the spacing member.

Accordingly, when the plurality of filter units 100 according to the present invention are connected to each other using the fastening bar 240 even while the respective filter units 100 are completely pressed against each other, the filter members 110 disposed to be parallel to each other may be spaced at a certain interval spaced apart through the spacing member. Accordingly, in the filter module 200, since raw water may be present on both sides of each of the filter members 110, the raw water may move into the filter member 110 from exteriors of both sides of the filter member 110 due to a suction force provided by the decompression portion 520 so as to produce filtered water.

In addition, when the second operation for removing foreign matter attached to the filter member 110 is performed after the first operation, the foreign matter attached to the filter member 110 may be separated from the filter member 110 and may fall into a space between the neighboring filter members 110.

Meanwhile, at least one of the interval adjusting members 130 and 130′ may include the receiving hole 133 configured to discharge filtered water moved along the flow channel 124 in each of the frames 120a and 120b.

That is, among the plurality of interval adjusting members 130 and 130′ coupled to the corners of the support frame 120, the interval adjusting member 130′ without the receiving hole 133 performs only a function of connecting the pair of neighboring frames. On the other hand, the interval adjusting member 130 with the receiving hole 133 may also perform a function, as an outlet, of discharging filtered water produced through the receiving hole 133.

The receiving hole 133 may be connected to the common collecting member 230 (refer to FIG. 3) which will be described below.

Here, the receiving hole 133 may be provided in only one of the plurality of interval adjusting members 130 and 130′ or may be provided in each of the two interval adjusting members 130 so as to be advantageous to providing a uniform suction pressure to the filter member 110.

In addition, the receiving hole 133 may be formed to be integrated with the body 131 of the interval adjusting member 130. However, a coupling hole may be formed in the body and thus the receiving hole having a certain length may be detachably coupled to the coupling hole. That is, the receiving hole may be provided as a hollow having a certain length and may be screw-coupled or insertion-coupled to the coupling hole formed in the body. Accordingly, when it is necessary to change or replace the receiving hole during the operation, only the receiving hole may be simply separated to be replaced or changed.

Here, when the interval adjusting member 130 with the receiving hole 133 is coupled to the two neighboring frames 120a and 120b, a collecting space 134 configured to communicate with the flow channels 124 formed in the two frames 120a and 120b may be formed at a position communicating with the receiving hole 133.

As an example, the collecting space 134 may be formed on the end sides of the two frames 120a and 120b which are inserted into the interval adjusting member 130 with the receiving hole 133 when the interval adjusting member 130 is coupled to the two frames 120a and 120b. The collecting space 134 may be formed by cutting the end of any one frame 120a of the two frames 120a and 120b, which are inserted into the interval adjusting member 130, not to be shape-matched with each other.

Accordingly, filtered water moving along the flow channel 124 formed in any one frame 120a of the two frames 120a and 120b and filtered water moving along the flow channel 124 formed in the other frame 120b may meet each other in the collecting space 134 and may be discharged outward through the receiving hole 133 communicating with the collecting space 134.

Accordingly, filtered water produced while moving from the outside to the inside of the filter member 110 due to a suction force provided by the decompression portion 520 during the first operation may flow into the respective flow channels 124 formed in the plurality of frames 120a and 120b, may move toward the collecting space 134 along the flow channel 124, and then may be discharged outward through the receiving hole 133.

Meanwhile, in the second operation, compressed air flowing inward through the receiving hole 133 due to the decompression portion 520 may be supplied to the respective flow channels 124 formed in the plurality of frames 120a and 120b via the modularized collecting space 134.

Meanwhile, the plurality of filter units 100 may be arranged to be parallel to each other and fixed to each other with the fastening bar 240 as a medium so as to be configured as one filter module 200.

As an example, as shown in FIG. 3, the filter module 200 may include the filter assembly 210, the fixing frame 220, and the common collecting member 230.

The filter assembly 210 may be formed by integrating the plurality of filter units 100, which are arranged to be parallel to each other, using one fastening bar 240 having a certain length.

Here, the filter assembly 210 may secure a certain space between the filter members 110 facing each other by arranging the neighboring filter members 110 to be spaced at a certain interval apart from each other using the spacing member provided in each of the filter unit 100. In addition, when fixing members 242 such as nuts are fastened to both sides of the fastening bar 240, the interval formed between the filter units 100 may be uniformly maintained.

The fixing frame 220 may be coupled to both end sides of the fastening bar 240 to be integrated with the filter assembly 210. The fixing frame 220 may be formed to be a plate-shaped member or may be provided to be a frame structure to allow raw water to flow into the filter assembly 210.

As an example, the fixing frame 220 may include a front frame 221 and a rear frame 222 disposed on a front side and a rear side of the filter assembly 210, respectively. Both end sides of the fastening bar 240 may be coupled to the front frame 221 and the rear frame 222, respectively. Accordingly, the filter assembly 210 and the fixing frame 220 may be integrated using the fastening bar 240.

Here, fastening holes (not shown) into which the end sides of the fastening bar 240 are inserted may be provided in the front frame 221 and the rear frame 222 to allow the end sides to be inserted thereinto using a fitting method. Through holes (not shown) passing through the front frame 221 and the rear frame 222 may be provided so as to allow both end sides of the fastening bar 240 to be fixed using an additional fixing member while passing therethrough.

Here, a separate handle 223 may be provided on one side of the fixing frame 220 to allow a user or worker to easily hold the modularized plate-shaped filter module 200.

Also, respective members forming the front frame 221 and the rear frame 222 may be plate-shaped bars having a certain width and length, may be an I-shaped beam and L-shaped beam, or may be provided to have an angular pipe shape.

As described above, in the plate-and-frame-type filter module 200 according to the present invention, the plurality of filter units 100 may be arranged to be parallel to each other and the filter members 110 provided in each of the filter units 100 may be arranged to be spaced at a certain interval spaced apart from each other using the spacing member. Accordingly, a suction force provided from the outside, for example, a suction force provided from the decompression portion 520, may be transferred to the plurality of filter units 100 through the respective receiving holes 133 so as to allow the plurality of filter units 100 to separately produce filtered water in one operation.

Accordingly, a large amount of filtered water may be produced using the plurality of filter units 100 at the same time and efficiency of producing filtered water may be increased.

The common collecting member 230 is configured to transfer a suction force to each of the filter units 100 to allow each of the filter units 100 to produce filtered water at the same time in one suction process and to integrate streams of the filtered water produced by respective filters as one.

That is, the common collecting member 230 is connected to the receiving hole 133 provided in each of the filter units 100 so as to transfer the suction force to each of the filter units at the same time, to allow each of the filter units 100 to separately produce filtered water using the transferred suction force, and to allow the streams of filtered water produced by the respective filter units 100 to flow into the common collecting member 230 via the collecting space 134 and the receiving hole 133 to be integrated.

In addition, the common collecting member 230 may perform a function of distributing high-pressure air to the respective filter units 100 in the second operation.

The common collecting member 230 may be provided as one common collecting member. However, when the filter unit includes a plurality of such receiving holes 133, the common collecting members 230 may be provided corresponding to the number of the receiving holes 133 to be connected to the respective receiving holes 133 one by one.

As an example, as shown in FIG. 3, when each of the filter units 100 includes two receiving holes 133 provided on an upper side and a lower side, two common collecting members 230 may also be provided. Here, any one of the two common collecting members 230 may be connected to the receiving hole 133 located on the upper side, and the other common collecting member 230 may be connected to the receiving hole 133 located on the lower side.

The common collecting member 230 may include a body 231 having a storage space 234 in which the filtered water flowing inward through the receiving hole 133 is temporarily collected, an inlet 232 through which the filtered water discharged from the receiving hole 133 flows into the storage space 234, and an outlet 233 through which the filtered water flowing into the storage space 234 is discharged outward (for example, into a filtered water storage tank 350) or the suction force provided from the outside is provided to the receiving hole 133.

Here, in the second operation for removing foreign matter attached to the filter member 110, the inlet 232 may perform a function of an outlet configured to supply high-pressure air to the filter unit 100, and the outlet 233 may perform a function of an inlet configured to suction high-pressure air provided from the outside into the common collecting member 230.

Here, a plurality of such inlets 232 may be provided to be connected to the respective receiving holes 133 provided in the filter units 100. The inlets 232 and the receiving holes 133 may be connected to each other to be matched with each other one by one.

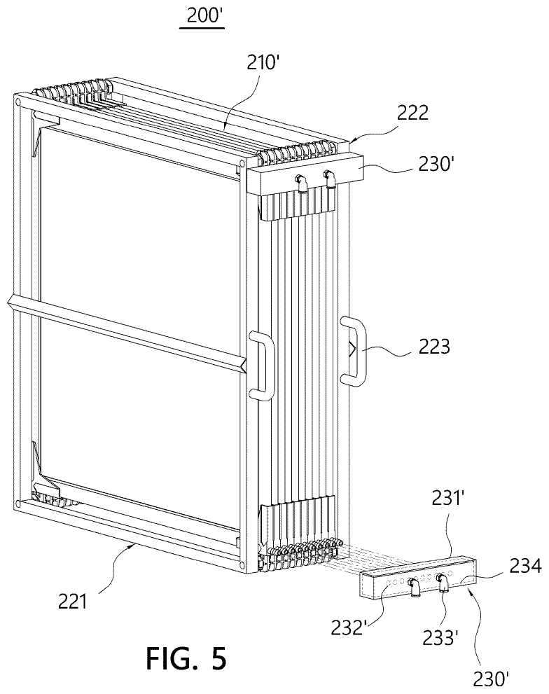

As an example, the plurality of inlets 232 may be connected to the receiving holes 133 one by one with a tube as a medium therebetween as shown in FIG. 3 or the receiving hole 133 may be directly connected to an inlet 232′ formed in a common collecting member 230′ as shown in FIG. 5.

Here, when the receiving hole 133 is directly connected to the inlet 232′ of the common collecting member 230′, the inlet 232′ is formed in a hole shape in one surface of a body 231′ having the storage space 234 in which the filtered water flowing inward from the receiving hole 133 is temporarily collected so that the receiving hole 133 formed to protrude to a certain length may be directly inserted into the inlet 232′. Here, a sealing member (not shown) configured to prevent filtered water from leaking outward may be provided on a contact surface between the inlet 232′ and the receiving hole 133.

Meanwhile, when the inlet 232 and the receiving hole 133 are connected to each other with a tube as a medium therebetween, the common collecting member 230 may be disposed in a middle part of a height of the fixing frame 220 to be spaced at a certain interval apart from the receiving hole 133.

This is because when the interval between the receiving hole 133 and the inlet 232 is excessively small, a tube may be bent while the tube is connected and may interfere with a smooth flow of filtered water.

As described above, in the filter module 200 employed in a sewage treatment system according to the present invention, the common collecting member 230 may be connected to the receiving holes 133 provided in the respective filter units 100 so as to allow the respective filter units to produce filtered water at the same time in one suction process and to perform the second operation for removing foreign matter attached to the respective filter members 110 at the same time. In addition, since the plurality of filter units 100 spaced at an adequate interval apart from each other may be integrated and modularized using the interval adjusting members 130 and 130′ so as to be simply installed and replaceable by unit module, there is an advantage of easy maintenance and repair.

Meanwhile, although one filter module 200 may be provided in the filtration portion 300 that is a plate-and-frame-type filter device, a plurality of such filter modules 200 may be provided and supported using a main frame as shown in FIG. 2. The main frame is configured to support the filter module 200 and may be formed as a hollow frame structure including a main flow channel 315 therein.

The main frame includes an upper main frame 311 disposed above the filter module 200 to firmly support the filter module 200 and a lower main frame 312 disposed below the filter module 200. The upper main frame 311 and the lower main frame 312 may be connected to each other using a plurality of support bars 313 as media.

Accordingly, the main frame may form a space portion to insert and dispose at least one filter module 200 therein.

Here, a guide rail 314 configured to support an edge side of the filter module 200 and to guide sliding of the filter module 200 when the filter module 200 is inserted may be provided on at least one of the upper main frame 311 and the lower main frame 312.

As an example, the guide rail 314 may be provided to have a rack type bar having an approximate L-shape and may be disposed in the same direction as an insertion direction of the filter module 200. Accordingly, since the edge side of the filter module 200 is supported when the filter module 200 is inserted, the filter module 200 may slide easily.

Preferably, the guide rail 314 may be formed on each of the upper main frame 311 and the lower main frame 312 to support an upper edge and a lower edge of the filter module 200 at the same time.

Meanwhile, the main flow channel 315 through which streams of filtered water flowing inward from the filter module 200 are integrated may be formed in at least one of the upper main frame 311 and the lower main frame 312.

As an example, the main flow channel 315 may be formed in any one of a plurality of members included in the lower main frame 312. In addition, the lower main frame 312 may include a plurality of fitting holes 316a and 316b configured to communicate with the main flow channel 315.

Here, the plurality of fitting holes 316a and 316b perform functions of an inlet and an outlet configured to suction and discharge filtered water. Some fitting holes 316a of the plurality of fitting holes 316a and 316b may be connected to the outlet 233 of the common collection member 230 using a connecting pipe 371 as a medium therebetween. Here, as the connecting pipe 371, a pipe member having rigidity may be used, or a well-known tube formed of a rubber material having flexibility may be used.

Also, other fitting holes 316b of the plurality of fitting holes 316a and 316b are connected to the filtered water storage tank 420 using the first flow channel 721 as a medium so that filtered water produced by each of the filter units may be transferred to the filtered water storage tank 420 due to a suction force provided by the decompression portion 520 in the first operation.

Here, when one filter module 200 is provided, the main frame 310 may be omitted. In this case, the outlet 233 of the common collecting member 230 may be directly connected to the filtered water storage tank 420.

The decompression portion 520 may be located in the first flow channel 721 and may provide a suction force to allow the filter unit 100 provided in each of the filter modules 200 to produce filtered water. Here, one side of the first flow channel 721 may be connected to at least any one fitting hole 316b among the fitting holes 316a and 316b of the main frame 310.

That is, in the first operation, a suction force provided by the decompression portion 520 may pass through the main flow channel 215, the common collecting member 230, and the receiving hole 133 and may be transferred to the filter member 110 through the flow channels 124 formed in the plurality of frames 120a and 120b constituting the support frame. Accordingly, raw water present around the filter unit 100 moves toward the filter member 110 and is filtered through the fiber web 112 due to the suction force. Due to the suction force, the filtered water passing through the fiber web 112 and moved to the first support body 111 may flow into the flow channel 124 of the support frame, may be moved to the collecting space 134, moved to the common collecting member 230 through the receiving hole 133 to be integrated, and collected in the filtered water storage tank 420 through the main flow channel 315 of the main frame and the first flow channel 721.

Accordingly, the sewage treatment system 1000 according to the present invention may produce a large amount of filtered water by operating the plurality of filter units 100 at the same time due to the suction force provided by the decompression portion 520 in the first operation.

In the sewage treatment system 1000 according to the present invention, the first operation is a filtration process using the filtration portion 300 which is the above-described plate-and-frame-type filter device. The filtration process is performed by forming a flow of raw water from the outside to the inside of the filter member 110 by allowing a pressure inside the filter member, for example, near the first support body 111, to be smaller than a pressure outside which are exteriors of both sides of the filter member 110 using the decompression portion 520. The produced filtered water may be transferred to the filtered water storage tank 420 through the first flow channel 721 while the first valve 610 is open and the second valve 620 is closed.

Here, the first operation may be performed so that membrane filtration flow velocity is 10 to 40 LMH. Accordingly, there are advantages of increasing a filtered water production amount and increasing efficiency of the following second operation. When a flow velocity is less than 10 LMH, a smaller amount of filtered water is gained and thus efficiency of producing filtered water may be decreased. Also, when a flow velocity exceeds 40 LMH, contamination of the filter member is intensified such that there is a risk that efficiency of the second operation is decreased. In more detail, the first operation may be performed for five to fifteen minutes so that the membrane filtration flow velocity becomes 10 to 40 LMH. +When the first operation is performed less than five minutes, the number and/or time of the second operation increases in a determined operation time such that there are risks that the filter member may be damaged or deformed and a gained filtered water amount may be decreased. Also, when the first operation is performed more than fifteen minutes, the number or time of the second operation decreases such that it is difficult to achieve adequate washing efficiency and a washing process is not performed at an appropriate time such that the filter member is contaminated with excessive foreign matter. Accordingly, there is a risk that it may become more difficult to remove the foreign matter from the filter member.

When the first operation is performed for a certain time, the first operation is stopped and the second operation is performed. The second operation is a washing process of removing contaminants in the filter member 110 by allowing air to pass from the inside to the outside of the filter member 110. In detail, the first valve 610 may be closed and the second valve 620 may be opened so that air stored in the air tank 430 may be transferred to the filter member 110 through the second flow channel 722 and the transferred air may be allowed to pass through from the inside to the outside of the filter member 110 so as to remove contaminants on the filter member 110 that is contaminated due to the first operation. The air stored in the air tank 430 may be supplied through an air supply portion 800, and the air supply portion 800 may be, for example, an air compressor.

According to one embodiment of the present invention, unlike that shown in FIG. 1, the second flow channel 722 may be directly connected to the filtration portion 300 and may directly supply air to the filter member 110 through the second flow channel 722 so as to perform a washing process. Here, a pressure of the air transferred through the second flow channel 722 may exceed 100 kPa. When the pressure is 100 kPa or less, foreign matter is not removed using only air. When the filter member 110 having a surface with an average opening diameter of 0.8 μm or less, particularly, 0.5 μm or less, is used, an air pressure is low, and thus it may be difficult to allow the air to pass through from the inside to the outside of the filter member 110, and thus the filter member may not be washed. Meanwhile, when the pressure exceeds 200 kPa, there is a risk that the filter member may be damaged or deformed by the air.

Meanwhile, according to one exemplary embodiment of the present invention, it is necessary to operate at a necessarily high pressure when the second operation is performed only using air. Accordingly, in order to prevent damage or deformation of the filter member caused by the operation performed at the high pressure and to more effectively remove foreign matter in the filter member 110, a washing process may be performed by allowing filtered water, which remains on a part of the first flow channel 721 between the filtration portion 300 and the first valve 610 closed after the first operation is finished, to pass through the filter member 110 with the air. In this case, there are advantages of implementing an adequate washing effect even when low-pressure air is applied in comparison to a case of using only air and minimizing the damage of the filter member 110. In other words, the second operation may be performed at a lower pressure in comparison to a case in which the second operation is performed only using air. Here, a pressure of the air may be 10 to 100 kPa and, particularly, may be 30 to 60 kPa. When the pressure of the air supplied, with remaining filtered water, to the filter member exceeds 100 kPa, there is a risk that damage or deformation of the filter member is caused while the air passes therethrough with the air. Also, when the pressure is less than 10 kPa, the air pressure is too low to provide an adequate washing effect even when used with the filtered water.

Meanwhile, in order to supply the filtered water remaining in the first flow channel 721 with the air to the filter member 110, the flow channel portion 720 may be designed so that a side of the second flow channel 722 which is opposite a side connected to the air tank 430 may communicate with a certain point P on the first flow channel 721 between the first valve 610 and the filtration portion 300 and pass through the first flow channel 721 to be connected to the filtration portion 300. Accordingly, in the second operation, the filtered water remaining in the first flow channel 721 between the first valve 610 and the filtration portion 300 and in the second flow channel 722 between the second valve 620 and the filtration portion 300 may pass through, with the air, from the inside to the outside of the filter member 110 so as to effectively remove contaminants on the filter member using a lower air pressure.

The second operation may be performed for 10 to 60 seconds. When the second operation is performed for less than 10 seconds, it is difficult to achieve an adequate washing effect. When the second operation is performed for more than 60 seconds, the damage or deformation of the filter member may be caused or improvement in a washing effect may be insignificant.

The first operation and the second operation may form one cycle and may be continuously repeated. Preferably, the cycle may be performed while further including a third operation of ventilating the filtration portion, in which the air remains due to the second operation, with outside air. The third operation is a process for relieving a pressure applied to the inside of the filter member 110 due to the air filling in the second flow channel 722 between the second valve 620 and the filtration portion 300 due to the second operation. The third operation may be performed by employing a suitable well-known method of relieving the pressure in the second flow channel 722. For example, the pressure in the second flow channel 722 may be relieved using a third valve installed in the second flow channel 722. When the first operation is performed after the second operation without the third operation, air remaining in the first flow channel is suctioned into a pressure applying device in the first operation such that the pressure applying device may not properly operate or a time consumed for operating may extend and thus efficiency of producing filtered water may be decreased. Meanwhile, when one side of the second flow channel 722 communicates with the first flow channel 721 like the design of the flow channel portion 720 shown in FIG. 1 according to one exemplary embodiment of the present invention, the third operation may also ventilate the first flow channel 721 between the first valve 610 and the filtration portion 300, which is filled with the air, with outside air. Also, in this case, it may be more efficient to install a third valve 640 on the first flow channel 721.

Meanwhile, the MBR system 1000 according to one embodiment of the present invention, in which water is treated by repetitively performing the first operation, the second operation, or performing the first operation to the third operation, may improve variations of differential pressure generated in the filter member 110 according to contamination of the filter member 110 during a water treatment operation. In order to minimize or prevent the variations of differential pressure, an average opening diameter of both surfaces of the filter member 110, for example, the fiber web 112, may be 0.5 μm or less, and more particularly, 0.3 μm or less. When the average opening diameter exceeds 0.5 μm, membrane contamination occurs more easily and frequently and removing foreign matter filling pores of the filter member 110 is also difficult, there is a risk that efficiency of the second operation is decreased, a range of variations in differential pressure increases, or the variations in differential pressure are not stable.

The MBR system 1000 according to one embodiment of the present invention may effectively remove the foreign matter in the filter member 110 so as to minimize the variations in differential pressure and to stabilize the variations even when the operation is continuously performed. As an example, when the first operation is performed with membrane filtration velocity of 20 LMH, after 100 days, a differential pressure of the filtration portion 300 may vary to be 10 kPa or less in comparison to an initial differential pressure so as to very stably treat sewage on a large scale for a long time. Also, washing is not performed using produced filtered water. Even when using the filtered water, only a small amount of filtered water remaining in a flow channel is used so that efficiency of producing filtered water may be greatly increased in comparison to a case in which washing is performed using filtered water.

Although the present invention will be described in detail through the following embodiments, it should be noted that the following embodiments do not limit the scope of the present invention and are intended to aid in understanding of the present invention.

### Preparation Example 1

A plate-and-frame-type filter device as shown in FIG. 2 was implemented. In detail, there was used a filter member in a filter unit employed in the filter device, in which second support bodies are disposed on both sides of a first support body and fiber webs formed of nanofibers were disposed on upper surfaces of the second support bodies, which are attached to each other through thermal fusion. In detail, the filter webs were used which were manufactured using a following method. Also, the filter webs were prepared to allow the implemented filter device to have effective membrane areas of 2.5 m² and 16 m².

In detail, in order to manufacture the fiber webs, a spinning solution was manufactured by dissolving 12 g of polyvinylidene fluoride (PVDF, Kynar 761, Arkema Company), as a fiber forming component, in 88 g of a mixed solvent in which dimethylacetamide and acetone were mixed at a weight ratio of 70:30 at a temperature of 80° C. for six hours using a magnetic bar. The spinning solution was inserted into a solution tank of an electric spinning device and was discharged at a velocity of 15 μl/min/hole. Here, a stacked body including a fiber web formed of PVDF nanofibers having an average diameter of 250 nm on one surface of the second support body was manufactured by maintaining a temperature of 30° C. and a humidity of 50% in a spinning section, forming a distance between a collector and a spinning nozzle tip to be 20 cm, disposing, as the second support bodies, non-woven fabric (CCP40, Nam Yang Nonwoven Fabric Co., Ltd) having a thickness of about 200 μm and a basis weight of 40 g/m² and formed of low-melting-point second composite fibers having an average diameter of 20 μm and including a sheath portion formed of polyethylene having a melting point of about 120° C. and a core portion formed of polypropylene above the collector, and applying a voltage of 40 kV to a spinning nozzle pack using a high-voltage generator and simultaneously applying an air pressure of 0.03 MPa per spinning nozzle pack. The manufactured fiber web was formed of nanofibers including a first nanofiber group having a diameter of 0.1 to 0.2 μm, a second nanofiber group having a diameter of 0.2 to 0.3 μm, and a third nanofiber group having a diameter of 0.3 to 0.4 μm at 35% by weight, 53% by weight, and 12% by weight, respectively, to have an average diameter of 250 nm and having a basis weight of 10 g/m², a thickness of 13 μm, an average opening diameter of 0.3 μm, and a porosity of about 75%.

Subsequently, in order to dry the solvent and moisture which remain on the fiber web of the stacked body and thermally fuse the second support body and the nanofiber web, a calendering process was performed by applying heat at a temperature of 140° C. or more and applying a pressure of 1 kgf/cm². In the manufactured stacked body, as shown in FIG. 6, the second support body and the nanofiber web were thermally fused and bonded and the nanofiber web was implemented to have a three-dimensional network structure.

Subsequently, the manufactured stacked body was disposed so that the second support bodies faced both surfaces of the first support body. Here, as the first support body, non-woven fabric (NP450, NamYang Nonwoven Fabric Co., Ltd) having a thickness of 5 mm and a basis weight of 450 g/m² and formed of low-melting point first composite fibers having a diameter of about 30 μm and including a sheath portion formed of polyethylene having a melting-point of about 120° C. and a core portion formed of polypropylene was used. Subsequently, heat at a temperature of 140° C. and a pressure of 1 kgf/cm² were applied so as to manufacture the filter member.

### Preparation Example 2

A plate-and-frame-type filter device having an effective filtration area of 2.5 m² was implemented by performing operations as in Preparation Example 1. However, a used fiber web had a basis weight of 6 g/m², a thickness of 13 μm, an average opening diameter of 0.8 μm, and a porosity of about 70%.

### Embodiment 1

A membrane bioreactor (MBR) system was configured as shown in FIG. 1. In detail, the plate-and-frame-type filter device according to Preparation Example 2 was accommodated, as a filtration portion, in a membrane filtration tub and then raw water having the concentration of about 12,000 mg/l was allowed to flow into the membrane filtration tub. The raw water was treated for 5.8 days by performing first to third operations as one cycle. In detail, the first operation was performed using a decompression portion for ten minutes so that membrane filtration flow velocity was LMH. Filtered water gained during the first operation was stored in a filtered water storage tank through a first flow channel. Subsequently, the first operation was stopped. A first valve was closed and a second valve was opened so that air was transferred from an air tank to a second flow channel. Then, the second operation was performed for twenty seconds to allow the air, with the filtered water remaining in the flow channel, to pass through from an inside to an outside of the filter member via the first flow channel. Here, a pressure of the air was set to be 50 kPa. Subsequently, the second operation was stopped and a third valve was opened so that the third operation of discharging the air remaining in the filter member or the like was performed for 120 seconds.

### Comparative Example 1

A water treatment operation was performed as in Embodiment 1 while the second operation and the third operation were omitted. In detail, it was repeated that the first operation was performed for ten minutes and paused for 140 seconds, and then the first operation was performed again.

### Experimental Example 1

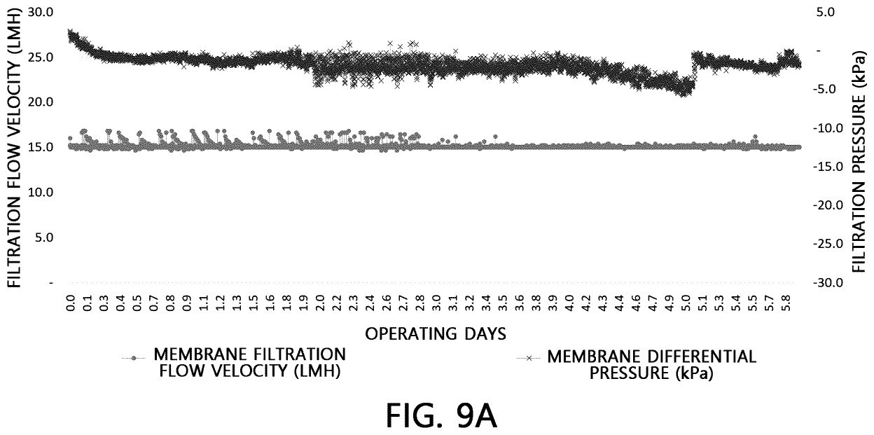

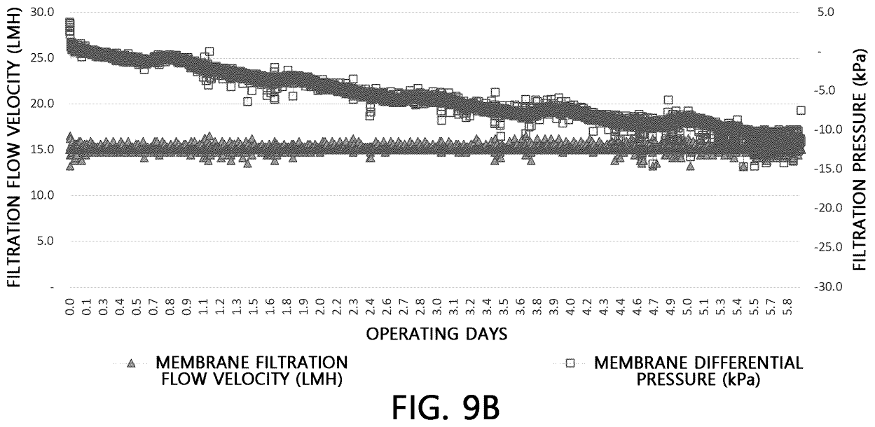

Membrane filtration flow velocities and membrane differential pressures according to water treatment operations of Embodiment 1 and Comparative Example 1 were measured as soon as they started and thus results thereof were shown in FIG. 9A (Embodiment 1) and FIG. 9B (Comparative Example 1), respectively.

As seen from FIGS. 9A and 9B, in the case of Comparative Example 1 in which the second operation was not performed, it can be seen that variations of 10 kPa or more occur in a differential pressure in comparison to an initial filtration pressure after 5.8 days. However, in the case of Embodiment 1 in which the second operation was performed using the air, it can be seen that stable variations of a differential pressure were less than 5 kPa even after 5.8 days.

### Embodiment 2

A membrane bioreactor (MBR) system was configured as shown in FIG. 1. In detail, the plate-and-frame-type filter device having an effective filtration area of 2.5 m² according to Preparation Example 1 was accommodated in a membrane filtration tub and then raw water having the concentration of about 12,000 mg/l was allowed to flow into the membrane filtration tub. The raw water was treated for 8.8 days by performing first to third operations as one cycle. In detail, the first operation was performed using a decompression portion for ten minutes so that membrane filtration flow velocity was 20 LMH. Filtered water gained during the first operation was stored in a filtered water storage tank through a first flow channel. Subsequently, the first operation was stopped. A first valve was closed and a second valve was opened so that air was transferred from an air tank to a second flow channel. Then, the second operation was performed for ten seconds to allow the air, with the filtered water remaining in the flow channel, to pass through from an inside to an outside of the filter member via the first flow channel. Here, a pressure of the air was set to be 30 kPa. Subsequently, the second operation was stopped and a third valve was opened so that the third operation of discharging the air remaining in the filter member or the like was performed for 110 seconds.

### Embodiment 3

Water treatment was performed like Embodiment 2 while the plate-and-frame-type filter device according to Preparation Example 2 was used, a second operation was performed, with an air pressure of 50 kPa, for 15 seconds, and a third operation was performed for 120 seconds.

### Experimental Example 2

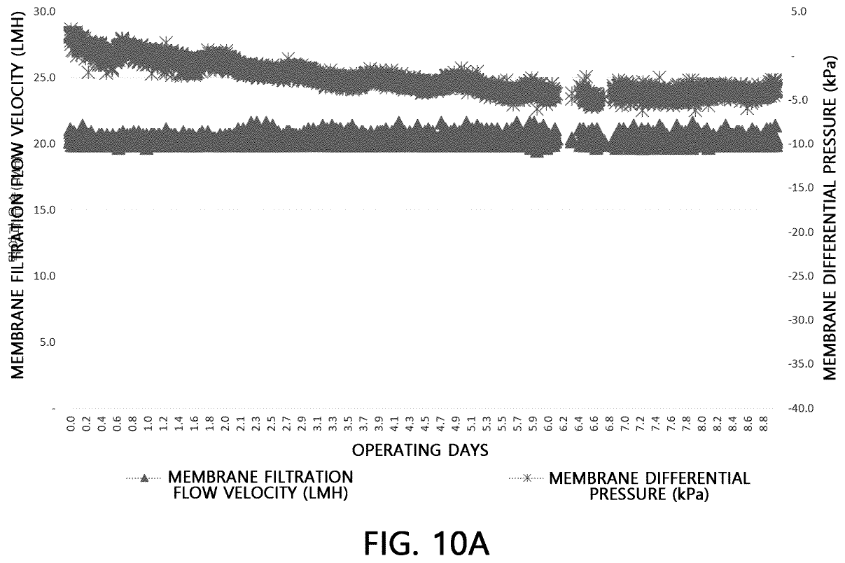

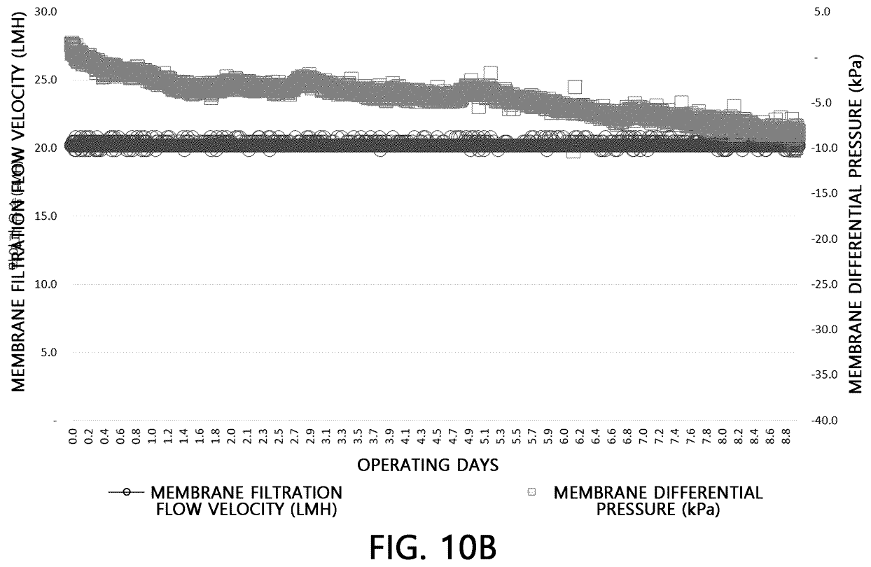

Membrane filtration flow velocities and membrane differential pressures according to water treatment operations of Embodiment 2 and Embodiment 3 were measured as soon as they started and thus results thereof were shown in FIG. 10A (Embodiment 2) and FIG. 10B (Embodiment 3), respectively.

As seen from FIGS. 10A and 10B, the plate-and-frame-type filter device of Embodiment 2 showed stable variations in differential pressure in water treatment in comparison to Embodiment 3. Particularly, since lower variations in differential pressure were shown even when the second operation was performed at lower pressure, it can be seen that Embodiment 2 is more optimized for water treatment operation conditions for the sewage treatment system according to the present invention.

### Embodiment 4

The plate-and-frame-type filter device having an effective filtration area of 2.5 m² according to Preparation Example 1 was accommodated in a membrane filtration tub and then raw water having the concentration of about 12,000 mg/l was allowed to flow into the membrane filtration tub. The raw water was treated for 15.6 days by performing first to third operations as one cycle. In detail, the first operation was performed using a pressure applying device for nine minutes so that membrane filtration flow velocity was 25 LMH. Filtered water gained during the first operation was stored in a filtered water storage tank through a first flow channel. Subsequently, the first operation was stopped. A first valve was closed and a second valve was opened so that air was transferred from an air tank to a second flow channel. Then, the second operation was performed for 12 seconds to allow the air, with the filtered water remaining in the flow channel, to pass through from an inside to an outside of the filter member via the first flow channel. Here, a pressure of the air was set to be 30 kPa. Subsequently, the second operation was stopped so that the third operation of discharging the air remaining in the filter member or the like was performed for 48 seconds.

### Comparative Example 2

Water treatment was performed like Embodiment 1 while air was not injected when the second operation was performed. Also, the second operation was performed for one minute to allow filtered water stored in a filtered water storage tank to pass through from an inside to an outside of the filter member at 48 LMH using a pressure pump additionally installed on a first flow channel. The first operation and the second operation were repetitively performed, without the third operation, for 15.6 days.

### Experimental Example 3

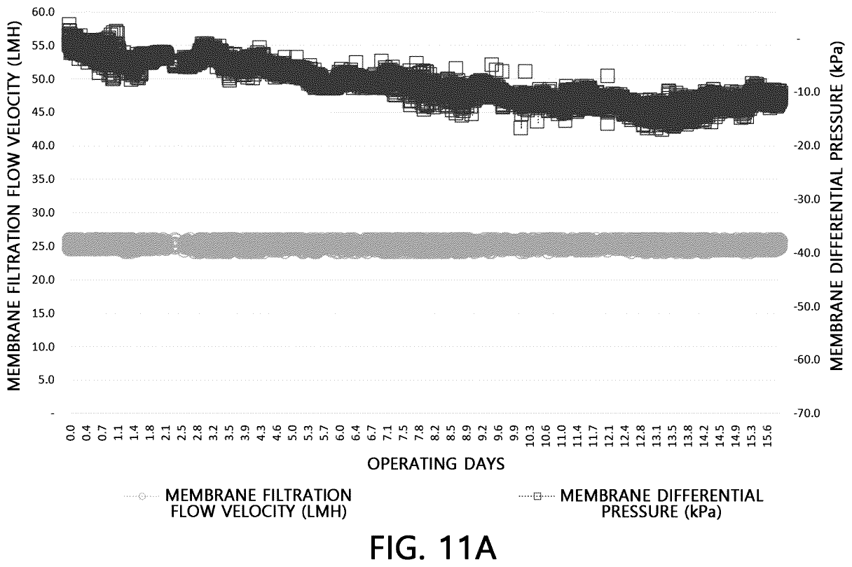

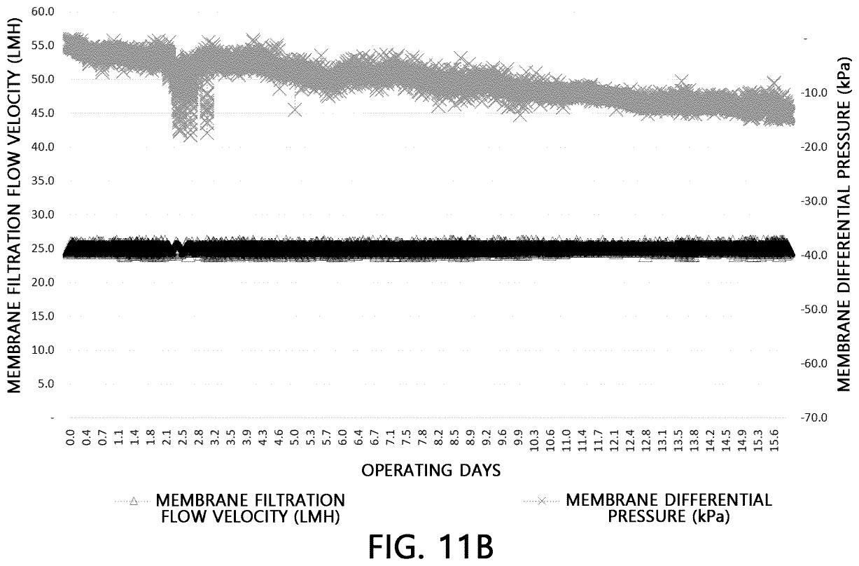

Membrane filtration flow velocities and membrane differential pressures according to water treatment operations of Embodiment 4 and Comparative Example 2 were measured as soon as they started and thus results thereof were shown in FIG. 11A (Embodiment 4) and FIG. 11B (Comparative Example 2), respectively.

As seen from FIGS. 11A and 11B, in the case of Embodiment 4 and Comparative Example 2 in which the second operation was performed using filtered water, it can be seen that similar variations in differential pressure were shown. Accordingly, it can be seen that similar washing effects are present.

Also, results with respect to water treatment in Embodiment 4 and Comparative Example 2 will be shown in Table 1.

TABLE 1

| | Embodiment | Comparative |
|---|---|---|
| Items | 4 | Example 2 |
| First operation time (minutes) | 9 | 9 |
| Second operation time (minutes) | 0.2 | 1 |
| Third operation time (minutes) | 0.8 | 0 |
| Daily total number of operations | 144.0 | 144.0 |
| (number of times) | | |
| Daily total times of first operation | 1296.0 | 1296.0 |
| (minutes/day) | | |
| Daily total times of second operation | 28.8 | 144.0 |
| (minutes/day) | | |
| Daily total times of third operation | 115.2 | 0.0 |
| (minutes/day) | | |
| Daily total operation times (minutes/day) | 1440.0 | 1440.0 |
| Daily amount of filtered water per unit | 1.35 | 1.35 |
| area (m²) (m³/day) | | |
| Daily amount of filtered water | 0.0 | 0.28 |
| used for second operation | | |
| per unit area (m²) (m³/day) | | |
| Daily discharge amount per unit area (m²) | 1.35 | 1.07 |
| (m³/day) | | |
| Membrane filtration operating capacity (%) | 90.00 | 90.00 |
| Membrane filtration collecting rate (%) | 100.0 | 79.6 |

As seen from Table 1, in the case of Comparative Example 2, it can be seen that a rate of collecting filtered water is notably decreased by about 20% in comparison to Embodiment 4, and Embodiment 4 shows a washing effect similar to Comparative Example 2 but shows very high efficiency in producing filtered water.

### Embodiment 5

A pilot sewage treatment system as shown in FIG. 1 capable of treating 12 m³ of sewage per day was prepared in a publicly owned treatment works located in Paju-si Gyeonggi-do, Korea. The plate-and-frame-type filter device according to Preparation Example 1 which had an effective filtration area of 16 m² was accommodated in a membrane filtration tub and raw water was allowed to flow thereinto. The raw water was treated for 103 days by performing first to third operations as one cycle. In detail, the first operation was performed using a decompression portion for nine minutes so that membrane filtration flow velocity was 25 LMH. Filtered water gained during the first operation was stored in a filtered water storage tank through a first flow channel. Subsequently, the first operation was stopped. A first valve was closed and a second valve was opened so that air was transferred from an air tank to a second flow channel. Then, the second operation was performed for 12 seconds to allow the air, with the filtered water remaining in the flow channel, to pass through from an inside to an outside of the filter member via the first flow channel. Here, a pressure of the air was set to be 30 kPa. Subsequently, the second operation was stopped so that the third operation of discharging the air remaining in the filter member or the like was performed for 48 seconds. As a result of the operation performed for 103 days, the concentration of activated sludge in the raw water was maintained to be 11,400 to 12,000 mg/L.

### Comparative Example 3

A water treatment operation was performed like Embodiment 5 while the second operation and the third operation were omitted. In detail, it was repeated that the first operation was performed for nine minutes and paused for 60 seconds, and then the first operation was performed again.

### Experimental Example 3

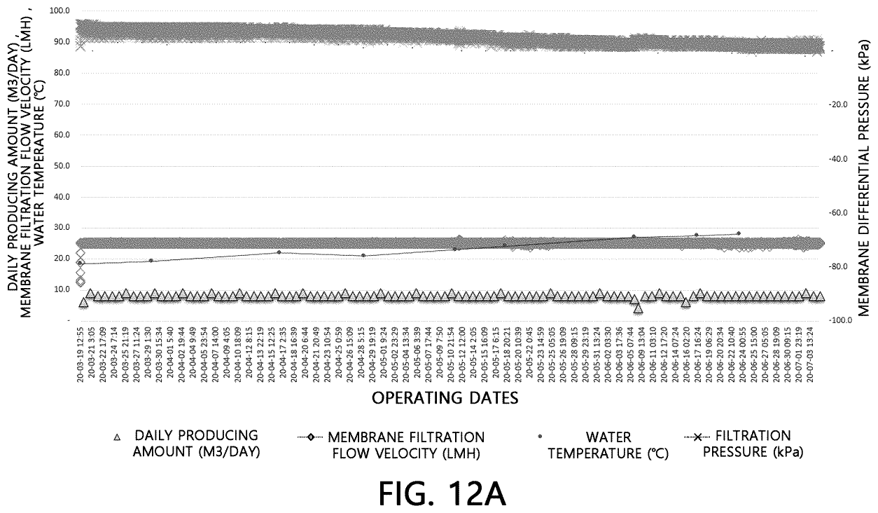

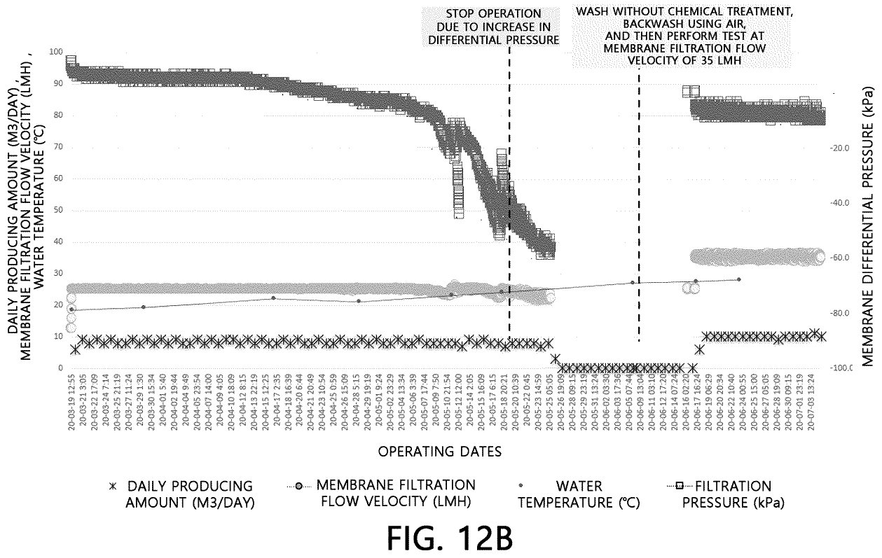

Membrane filtration flow velocities and membrane differential pressures according to water treatment operations of Embodiment 5 and Comparative Example 3 were measured as soon as they started and thus results thereof were shown in FIG. 12A (Embodiment 5) and FIG. 12B (Comparative Example 3), respectively.

As seen from FIGS. 12A and 12B, in the case of Comparative Example 3 notated as a second line in which a washing process for the filter member through the second operation was not performed, it can be seen that since a filtration pressure increased to −60 kPa after operation for about 67 days, the operation was stopped and may be performed again after performing a washing process for the filter member using chemicals.

Meanwhile, in the case of Embodiment 5 notated as a first line, it can be seen that variations of membrane differential pressure from an initial filtration pressure of 10 kPa to a filtration pressure of 2 kPa after operation performed for accumulative 103 days are just at −8 kPa levels and the membrane differential pressure is stably maintained.

Also, as a result of checking a rate of removing Escherichia coli and suspended solid (SS) with respect to filtered water gained after performing the sewage treatment operation according to Embodiment 5 for 30 days, SS and Escherichia coli are not detected, and thus it can be seen that filtration efficiency is high.

### Embodiment 6

In order to check allowable membrane filtration flow velocity in a first operation, sewage treatment was performed like Embodiment 5 for about 15 days while a filtration flow velocity was changed to 35 LMH in the first operation.

### Experimental Example 4

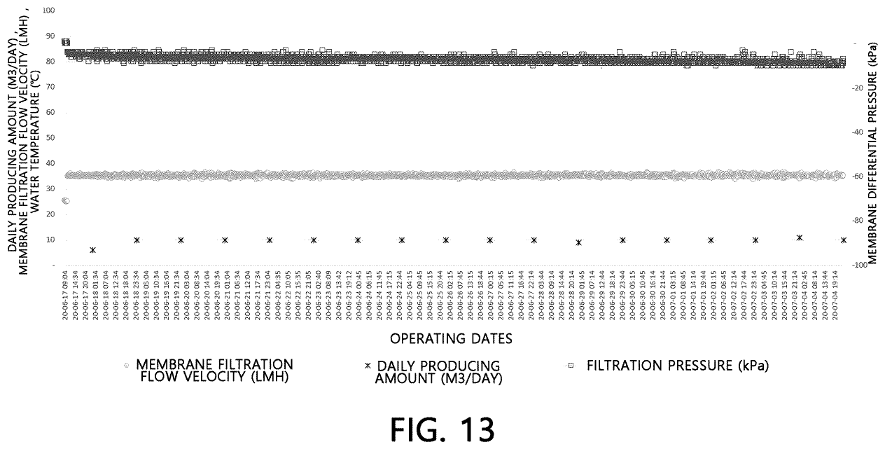

A membrane filtration flow velocity and membrane differential pressure according to water treatment operation of Embodiment 6 were measured as soon as the operation started, and thus a result thereof was shown in FIG. 13.

As seen from FIG. 13, in the case of Embodiment 6 notated as the second line, it can be seen that the membrane differential pressure is stably maintained even when the membrane filtration flow velocity is changed from 25 LMH to 35 LMH.

### Embodiments 7 and 8

Sewage treatment was performed like Embodiment 4 while repetitively performing first to third operations including an additional process of transferring all filtered water in a first flow channel to a filtered water tank by adjusting equipment of the first flow channel not to allow the filtered water to remain in the first flow channel between the first operation and the second operation. Here, in Embodiment 7, an air pressure was equal to that of Embodiment 4. In Embodiment 8, an air pressure was adjusted to be 60 kPa.

### Experimental Example 5

Membrane filtration flow velocities and membrane differential pressures according to water treatment operations of Embodiment 4 and Embodiment 7 were measured as soon as they started and thus membrane differential pressure variations after five days and 15 days are shown in Table 2.

TABLE 2

| | | Embodiment | Embodiment | Embodiment |
|---|---|---|---|---|
| | | 4 | 7 | 8 |
| Membrane filtration | | 25 | 25 | 25 |
| flow velocity (LMH) | | | | |
| in first operation | | | | |
| Whether filtered | | Present | None | None |
| water remains in | | | | |
| first flow channel | | | | |
| after first operation | | | | |
| Air pressure (kPa) | | 30 | 30 | 60 |
| in second operation | | | | |
| Variations in | After | Less | Less | Less |
| membrane | 5 days | than 5 | than 5 | than 5 |
| differential | After | Less | Maximum | Maximum |
| pressure (kPa) | 15 days | than 5 | 9.5 | 6.8 |

As results of evaluation, in the case of Embodiment 1, variations in differential pressure were maintained to be less than 5 kPa for 15 days. In the case of Embodiments 7 and 8, variations in differential pressure were maintained to be less than 5 kPa for about five days and variations of 9.5 kPa and 6.8 kPa in differential pressure occurred after 15 days. Accordingly, it can be seen that when the second operation is performed by allowing air to pass without filtered water in the first flow channel, variations in membrane differential pressure can be reduced by only applying a higher air pressure. However, in the case of Embodiment 4, even when the second operation is performed at an air pressure of 30 kPa levels, variations in membrane differential pressure are stably maintained to be less than 5 kPa. Accordingly, it can be seen that efficiency of the second operation can be increased when air is allowed to pass, with a small amount of filtered water remaining in the first flow channel, through the filter member.

Although the embodiments of the present invention have been described above, the concept of the present invention is not limited to the embodiments disclosed herein and it should be understood that one of ordinary skill in the art who understands the concept of the present invention may easily provide other embodiments through attachment, change, elimination, addition, and the like of components without departing from the scope of the same concept which will be included in the scope of the concept of the present invention.

I claim:

1. A method for operating a membrane bioreactor (MBR) system, the MBR system comprising:
a membrane filtration tub configured to contain raw water, wherein a concentration of activated sludge is 3,000 to 15,000 mg/l;
a filtration portion including a plate-shaped filter member and installed in the membrane filtration tub;
a filtered water storage tank disposed outside the membrane filtration tub and configured to store the filtered water produced from the filtration portion;
an air tank configured to store air to be supplied to the filtration;
a flow channel portion comprising a first flow channel configured to connect the filtration portion to the filtered water storage tank and a second flow channel configured to connect the filtration portion to the air tank;
a valve portion comprising a first valve located on the first flow channel and configured to open or close the first flow channel and a second valve located on the second flow channel and configured to open or close the second flow channel; and
a decompression portion located on the first flow channel between the filtered water storage tank and the first valve,
wherein the MBR system repetitively performs one cycle comprising:
a first operation in which filtered water is produced by allowing raw water contained in the membrane filtration tub to pass through from an outside to an inside of the filter member in the filtration portion by driving the decompression portion and transferring the produced filtered water to the filtered water storage tank through the first flow channel while the first valve is opened and the second valve is closed; and
a second operation in which the air stored in the air tank is transferred to the filter member through the second flow channel by closing the first valve and opening the second valve and contaminants on the filter member contaminated due to the first operation are removed by allowing the transferred air to pass through from the inside to the outside of the filter member.

2. The method of claim 1, wherein the valve portion further comprises a third valve connected to outside air on the first flow channel between the first valve and the filtration portion, and
wherein the cycle further comprises a third operation of ventilating the filtration portion, in which the air remains due to the second operation, with outside air by closing the second valve and opening the third valve after the second operation is finished.

3. The method of claim 1, wherein the first operation is performed so that a membrane filtration flow velocity is to be 10 to 40 LMH.

4. The method of claim 1, wherein in the second operation, a pressure of the air exceeds 100 kPa.

5. The method of claim 1, wherein a side of the second flow channel, which is opposite a side connected to the air tank, communicates with a certain point on the first flow channel between the first valve and the filtration portion and is connected to the filtration portion via the first flow channel, and
wherein in the second operation, filtered water remaining in the first flow channel between the first valve and the filtration portion and the second flow channel between the second valve and the filtration portion passes, with the air, through from the inside to the outside of the filter member so as to remove the contaminants on the filter member.

6. The method of claim 5, wherein an average opening diameter of a surface of the filter member which faces raw water is 0.5 μm or less, and
wherein a pressure of the air is 10 to 100 kPa.

7. The MBR system of claim 2, wherein the first operation is performed at a membrane filtration flow velocity of 10 to 40 LMH for 5 to 15 minutes,
wherein the second operation is performed using air at a pressure of 10 to 100 kPa for 10 to 60 seconds, and
wherein the third operation is performed for 10 to 120 seconds.

8. The method of claim 1, wherein when the first operation is performed at a membrane filtration flow velocity of 20 LMH, a differential pressure of the filtration portion after 100 days varies to be 10 kPa or less in comparison to an initial differential pressure.

9. The method of claim 1, wherein the filtration portion is a plate-and-frame-type filter device comprising:
a filter assembly in which a plurality of filter units are integrated using a fastening bar as a medium; and
at least one common collecting member configured to collect filtered water discharged from the plurality of filter units,
wherein the filter unit comprises a filter member which is a flat sheet membrane having a filtration flow from an outside, which includes both surfaces, to an inside, a support frame coupled to an edge side of the filter member to support the filter member and in which a flow channel through which the filtered water produced using the filter member flows in and moves and a receiving hole configured to discharge the filtered water are formed, and
wherein the common collecting member is connected to be matched one to one with the receiving hole, which is provided in each of the plurality of filter units.

10. The method of claim 1, wherein the filter member comprises a first support body and fiber webs formed of nanofibers and disposed on both sides of the first support body.

11. The method of claim 10, wherein the fiber webs are attached to surfaces of the first support body using second support bodies having a thickness smaller than the first support body as a media through thermal fusion.

12. The method of claim 11, wherein the first support body and the second support bodies are sheath-core composite fibers comprising a core portion formed of polypropylene and a sheath portion formed of polyethylene having a melting point at a temperature of 60 to 180° C.
